(19) United States
(12) Patent Application Publication
(10) Pub. No.: US 2012/0002785 A1
(43) Pub. Date: Jan. 5, 2012

(54) Grating production method, diffraction grating device, and radiation imaging apparatus

(75) Inventor: Yasuhisa Kaneko, Kanagawa (JP)

(73) Assignee: FUJIFILM Corporation, Tokyo (JP)

(21) Appl. No.: 13/067,803

(22) Filed: Jun. 28, 2011

(30) Foreign Application Priority Data
Jun. 30, 2010 (JP) 2010-150135

(51) Int. Cl. G01N 23/04; B23P 11/00; G02B 5/18

(52) U.S. Cl. 378/62; 359/566; 29/428

(57) ABSTRACT

An X-ray imaging apparatus includes a diffraction grating device. The diffraction grating device has a composite grating, including small grating plates having radiopaque areas and radio-transparent areas arranged in a grating pattern, and a first support plate being radio-transparent, for receiving the small grating plates secured thereto. A first holding plate being radio-transparent retains the composite grating thereon. The first holding plate includes a concave surface for retaining and curving the composite grating. A second holding plate being radio-transparent is secured to the composite grating, for sandwiching in cooperation with the first holding plate. Also, an opening is formed in each of the holding plates to open in an area of the small grating plates. A clamping cap squeezes the holding plates for sealing. Also, a second support plate being radio-transparent sandwiches the small grating plates with the first support plate.

### BACKGROUND OF THE INVENTION

1. Field of the Invention

The present invention relates to a grating production method, diffraction grating device, and radiation imaging apparatus. More particularly, the present invention relates to a grating production method capable of producing a diffraction grating in which small grating plates area arranged sufficiently precisely, diffraction grating device, and radiation imaging apparatus.

2. Description Related to the Prior Art

An X-ray imaging system in which Talbot effect as interference effect is utilized is one type of X-ray phase imaging. A phase contrast image of an object or body is produced according to a change of the phase or change of the angle of X-rays through the body.

The X-ray imaging system includes a first diffraction grating, a second diffraction grating and an X-ray image detector. The first diffraction grating is disposed behind the body. The second diffraction grating is disposed downstream of the first diffraction grating in a travel direction of X-rays by a Talbot interference distance which is determined according to a grating pitch of the first diffraction grating and a wavelength of the X-rays. The X-ray image detector is disposed downstream of the second diffraction grating. The X-rays are transmitted through the first diffraction grating, and forms a fringe image at a point of the second diffraction grating according to the Talbot effect as interference effect. The fringe image is modulated by interaction (phase change) between the body and the X-rays. The fringe image after intensity modulation in combination with the second diffraction grating is detected according to fringe scan method, so that a phase contrast image of the body can be obtained from a change or phase difference of the fringe image of the body.

The first and second diffraction gratings have a grating pattern in which X-ray transparent areas and radiopaque areas for X-rays are arranged alternately, the X-ray transparent areas transmitting the X-rays, the radiopaque areas absorbing and blocking the X-rays. To detect changes in the fringe image with the body, the structure requires a very fine form in which a pitch of the radiopaque areas in the arrangement direction is as great as several microns. High X-ray opacity is required in the radiopaque areas in the first and second diffraction gratings, their thickness in a travel direction of the X-rays is as great as hundreds of microns, to make a structure of a high aspect ratio. To this end, a semiconductor process of silicon is used to fabricate the first and second diffraction gratings because of suitability for a fine production.

To enlarge a size of a field of view in the X-ray imaging system, there is conception of enlarging an area of the first and second diffraction gratings. However, a size of a wafer processable in the second diffraction grating is limited. A diffraction grating larger than the wafer cannot be produced.

If the first and second diffraction gratings have a large area, it is necessary to cope with optical vignetting of the X-rays in a peripheral portion of those and to control convergence in a thickness direction of the diffraction grating. Specifically, an X-ray source is considered as a point radiation source. When the X-rays are emitted from the X-ray source in a cone beam shape, a spot size of the X-rays is enlarged by an amount of a distance from the X-ray source. A wave surface of the X-rays becomes curved because of an equidistant condition from the X-ray source. Thus, an angle of incidence of the X-rays is different between a center of the diffraction grating and the peripheral portion. The optical vignetting occurs in use of the diffraction grating of the large area because the angle of the X-rays at the peripheral portion is not parallel with a direction of the diffraction grating according to the difference in the angle of incidence. The optical vignetting causes occurrence of a non transmission area and limits an active area of the grating.

JP-A 9-304738 and JP-A 2001-330716 disclose a suggestion of at least one array of plural small grating plates for the purpose of enlarging an entire area of the first and second diffraction gratings. To minimize the optical vignetting of the X-rays in the peripheral portion of the first and second diffraction gratings of which the area is enlarged, it may be possible to shape the first and second diffraction gratings in a curved form corresponding to a wave surface of the X-rays. Production of the first and second diffraction gratings with a large area and also without the optical vignetting of the X-rays requires combination of the known suggestion and the curved form. However, it is extremely difficult to arrange the small grating plates on a curve surface because of their flat and fine structure. No method for production of this is known.

### SUMMARY OF THE INVENTION

In view of the foregoing problems, an object of the present invention is to provide a grating production method capable of producing a diffraction grating in which small grating plates area arranged sufficiently precisely, diffraction grating device, and radiation imaging apparatus.

In order to achieve the above and other objects and advantages of this invention, a grating production method of producing a diffraction grating device includes a step of securing at least one small grating plate to a first support plate being radio-transparent to obtain a composite grating, the small grating plate having radiopaque areas and radio-transparent areas arranged in a grating pattern. The composite grating is curved to obtain the diffraction grating device.

The small grating plate is constituted by plural small grating plates arranged in aligning the radiopaque areas thereof.

Furthermore, a second support plate being radio-transparent is secured to the small grating plate secured to the first support plate, to sandwich the small grating plate between the first and second support plates.

In the curving step, the composite grating is curved along a concave or convex first surface of a first holding plate.

The curving step includes holding the composite grating for curving by suction of a suction device being concave or convex corresponding to the first surface. One of the suction device and the first holding plate is moved relatively toward another thereof. The suction of the suction device is discontinued to set the composite grating on the first surface.

The first holding plate has an opening formed in an area of the small grating plate. The moving of the composite grating includes retaining the composite grating held on the suction device by use of an additional support pad disposed movably into and out of the opening. The composite grating is squeezed between the first holding plate and the suction device by moving the first holding plate toward the composite grating. The suction device and the support pad are moved away from the composite grating.

A second holding plate is further placed on the composite grating retained on the first holding plate, to sandwich the composite grating between the first and second holding plates.

The second holding plate has an opening open in an area of the small grating plate.

The small grating plate includes a reinforcing portion formed along a peripheral edge thereof.

The first support plate includes an indicia for positioning the small grating plate to be secured.

The indicia is a projection for receiving contact of edges of the small grating plate.

Also, a diffraction grating device is provided, and includes at least one small grating plate having radiopaque areas and radio-transparent areas arranged in a grating pattern. First and second support plates being radio-transparent are secured to the small grating plate, for sandwiching thereof.

Furthermore, a first holding plate being radio-transparent retains a composite grating including the small grating plate and the first and second support plates.

The first holding plate includes a first surface being concave or convex, for retaining and curving the composite grating.

Furthermore, a second holding plate being radio-transparent is secured to the composite grating, for sandwiching in cooperation with the first holding plate.

Furthermore, an opening is formed in each of the first and second holding plates to open in an area of the small grating plate.

Furthermore, a clamping portion squeezes the first and second holding plates for sealing.

The small grating plate is constituted by plural small grating plates arranged to align the radiopaque areas thereof in a grating pattern.

Furthermore, a reinforcing portion reinforces a peripheral portion of the small grating plate.

Also, a diffraction grating device is provided, and has a composite grating, including at least one small grating plate having radiopaque areas and radio-transparent areas arranged in a grating pattern, and a first support plate being radio-transparent, for receiving the small grating plate secured thereto. A first holding plate being radio-transparent retains the composite grating thereon.

The first holding plate includes a first surface being concave or convex, for retaining and curving the composite grating.

Furthermore, a second support plate being radio-transparent sandwiches the small grating plate in cooperation with the first support plate.

Also, a radiation imaging apparatus includes a radiation source for emitting radiation. A first diffraction grating device creates a fringe image by transmitting the radiation. There is a second diffraction grating device for intensity modulation of the fringe image in plural relative positions being out of phase with a fringe pattern of the fringe image. A radiation detector detects the fringe image after the intensity modulation in the relative positions from the second diffraction grating device. At least one of the first and second diffraction grating devices includes at least one small grating plate having radiopaque areas and radio-transparent areas arranged in a grating pattern. First and second support plates being radio-transparent are secured to the small grating plate, for sandwiching thereof.

Also, a radiation imaging apparatus includes a radiation source for emitting radiation. A first diffraction grating device creates a fringe image by transmitting the radiation. There is a second diffraction grating device for intensity modulation of the fringe image in plural relative positions being but of phase with a fringe pattern of the fringe image. A radiation detector detects the fringe image after the intensity modulation in the relative positions from the second diffraction grating device. At least one of the first and second diffraction grating devices includes a composite grating, including at least one small grating plate having radiopaque areas and radio-transparent areas arranged in a grating pattern, and a first support plate being radio-transparent, for receiving the small grating plate secured thereto. A first holding plate being radio-transparent retains the composite grating thereon.

Consequently, it is possible to produce a diffraction grating in which small grating plates area arranged sufficiently precisely, because of the use of the support plate and the curving operation.

### BRIEF DESCRIPTION OF THE DRAWINGS

The above objects and advantages of the present invention will become more apparent from the following detailed description when read in connection with the accompanying drawings, in which:

FIG. 1 is an exploded perspective view illustrating an X-ray imaging apparatus;

FIG. 2 is a plan illustrating a second diffraction grating device;

FIG. 3 is an explanatory view illustrating the second diffraction grating device of which small grating plates are curved;

FIG. 4A is a cross section illustrating a step of overlaying an etching substrate on a conductive substrate in production of the small grating plate;

FIG. 4B is a cross section illustrating a step of forming an etching mask on the etching substrate;

FIG. 4C is a cross section illustrating a step of forming plural grooves in the etching substrate;

FIG. 4D is a cross section illustrating a step of depositing gold in the etching substrate;

FIG. 5 is a perspective view illustrating one preferred embodiment of the second diffraction grating device;

FIG. 6 is an exploded perspective view illustrating the second diffraction grating device;

FIG. 7A is a side elevation illustrating a step of placing the small grating plates on a first support plate in production of the second diffraction grating device;

FIG. 7B is a side elevation illustrating a step of attaching a second support plate to the small grating plates;

FIG. 7C is a side elevation illustrating a step of holding a composite grating with a suction pad;

FIG. 7D is a side elevation illustrating a step of sandwiching the composite grating between the concave and convex holding plates;

FIG. 7E is a side elevation illustrating a step of squeezing the composite grating with the concave and convex holding plates between a clamping portion;

FIG. 8 is an exploded perspective view illustrating another preferred embodiment of a second diffraction grating device;

FIG. 9 is an exploded perspective view illustrating the second diffraction grating device;

FIGS. 10A, 10B, 10C, 10D and 10E are vertical sections illustrating a sequence of producing the second diffraction grating device;

FIG. 11 is a plan illustrating a further preferred embodiment of small grating plates;

FIG. 12 is a vertical section illustrating a curved form of a composite grating;

FIG. 13 is a plan illustrating a variant of a small grating plate;

FIG. 14 is a plan illustrating another variant of a small grating plate;

FIG. 15A is a plan illustrating still another preferred embodiment of second diffraction grating device;

FIG. 15B is a cross section illustrating the second diffraction grating device;

FIG. 16 is a side elevation illustrating an additional preferred embodiment of second diffraction grating device;

FIG. 17 is a side elevation illustrating a variant of the second diffraction grating device;

FIG. 18 is a side elevation illustrating yet another preferred composite grating;

FIG. 19 is a side elevation illustrating a diffraction grating device including the composite grating;

FIG. 20 is a side elevation illustrating another diffraction grating device including the composite grating of FIG. 18;

FIG. 21 is a side elevation illustrating still another diffraction grating device including the composite grating of FIG. 18;

FIG. 22A is a side elevation illustrating another preferred diffraction grating device;

FIG. 22B and 22C are side elevations illustrating variants of diffraction grating device;

FIG. 23 is an explanatory view in a side elevation illustrating a comparative example in a sequence of attachment.

### DETAILED DESCRIPTION OF THE PREFERRED EMBODIMENT(S) OF THE PRESENT INVENTION

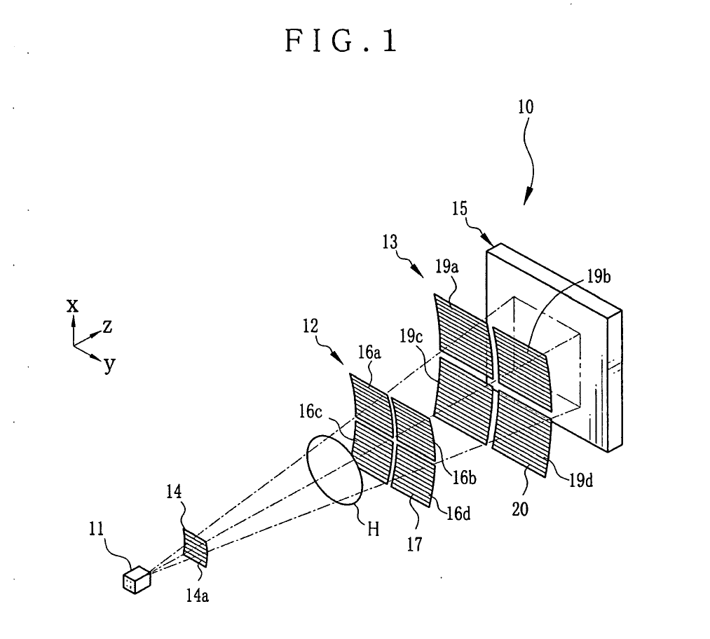

An X-ray imaging apparatus 10 or radiation imaging apparatus of FIG. 1 is described. The X-ray imaging apparatus 10 includes an X-ray source 11, a first diffraction grating device 12, a second diffraction grating device 13, a third diffraction grating device 14, and an X-ray image detector 15. The X-ray source 11 applies X-rays to an object or body H disposed in the z-direction. The first diffraction grating device 12 is a phase type of diffraction grating, and opposed to the X-ray source 11 in the z-direction. The second diffraction grating device 13 is an amplitude type of diffraction grating, and disposed downstream of the first diffraction grating device 12 in the z-direction by an amount of a Talbot interference distance. The third diffraction grating device 14 is an absorption type of diffraction grating disposed directly behind the X-ray source 11. The X-ray image detector 15 is a radiation detector opposed to the second diffraction grating device 13. An example of the X-ray image detector 15 is an FPD device (flat panel detector) constituted by semiconductor devices.

Four small grating plates 16a, 16b, 16c and 16d are arranged adjacently in two arrays, and constitute the first diffraction grating device 12. Radiopaque areas 17 are present in the small grating plates 16a-16d, extend linearly in the y-direction which is perpendicular to the z-direction, and are arranged at a regular pitch in the x-direction which is perpendicular to the z and y-directions. X-ray transparent areas (radio-transparent areas) or grating spacings are defined between the radiopaque areas 17.

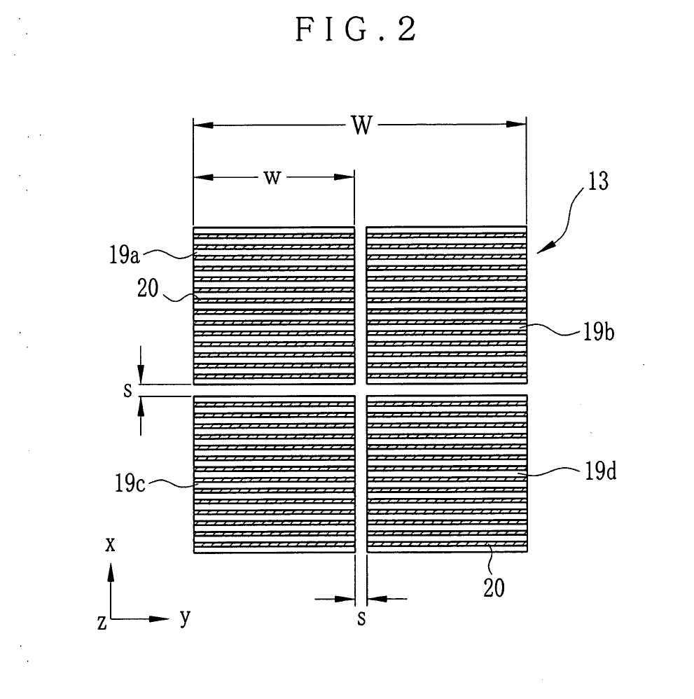

In a manner similar to the first diffraction grating device 12, the second diffraction grating device 13 is constituted by four small grating plates 19a, 19b, 19c and 19d. The small grating plates 19a-19d are respectively in a shape of a square with sides of a width w of 10 cm, and arranged at an interval s of 100 microns. In FIG. 2, the second diffraction grating device 13 containing the small grating plates 19a-19d is in a large shape of a square with sides of a total width W of approximately 20 cm. Plural radiopaque areas 20 are disposed in each of the small grating plates 19a-19d in a manner similar to the small grating plates 16a-16d, extend in the y-direction, and are arranged at a regular pitch in the x-direction. X-ray transparent areas or grating spacings are defined between the radiopaque areas 20.

Also, the third diffraction grating device 14 includes radiopaque areas 14a and X-ray transparent areas between the radiopaque areas 14a. The radiopaque areas 14a extend in the y-direction, and are arranged at a regular pitch in the x-direction. Examples of material for the radiopaque areas 14a, 17 and 20 include gold, platinum, lead and the like having high absorbance (radiopacity) for X-rays.

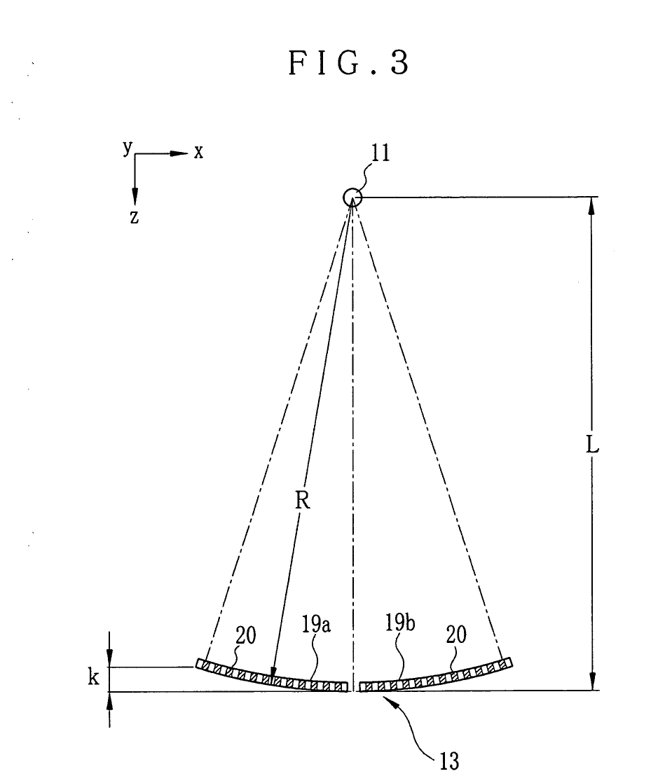

The diffraction grating devices 12-14 are curved for preventing vignetting of X-rays of a cone beam shape in peripheral areas. The X-ray image detector 15 extends in parallel with the first and second diffraction grating devices 12 and 13. Curved surfaces of the diffraction grating devices 12-14 are arcuate on an arc defined about a center line which passes a focal point of the X-ray source 11 and in the y-direction being perpendicular to the z-direction. The second diffraction grating device 13 is described now by referring to FIG. 3. Let L be a distance from the focal point of the X-ray source 11 to the second diffraction grating device 13. If L is 200 cm, the second diffraction grating device 13 is curved at a radius R of 200 cm. Let k be a curve height of the curvature required for passing the X-rays of the cone beam shape in the peripheral points of the second diffraction grating device 13. The curve height k is approximately 3 mm. The curve height k is a distance from the center of the second diffraction grating device 13 to its peripheral points in the z-direction.

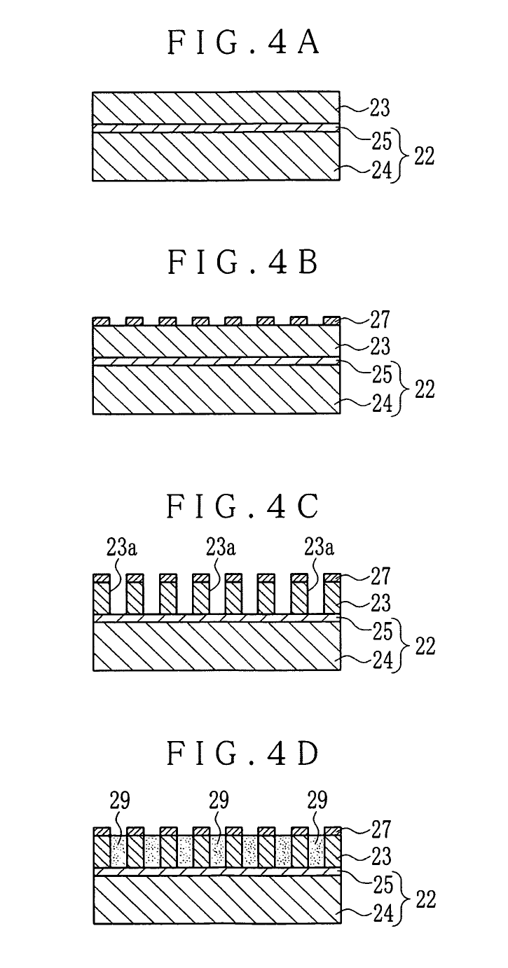

The small grating plates 16a-16d and 19a-19d and the third diffraction grating device 14 are formed by a semiconductor process of silicon. The following is description of production of the small grating plate 19a. In FIG. 4A, a silicon substrate 23 is attached to a conductive substrate 22 as abase for the small grating plate 19a. The conductive substrate 22 includes a support 24 and a conductive thin film 25 overlaid on the support 24. A material of the support 24 is an organic material having low absorbance for X-rays and having flexibility. A material of the conductive thin film 25 is Au, Ni or other metal. The silicon substrate 23 is a silicon wafer for etching.

In FIG. 4B, the silicon substrate 23 is processed in photolithography as a well-known technique, so that an etch mask 27 is formed on its upper surface. The etch mask 27 includes a pattern of stripes extending linearly in a direction perpendicular to a surface of the drawing, and arranged at a regular pitch horizontally. In FIG. 4C, the etch mask 27 is etched in dry etching, so that plural etched grooves 23a are formed in the silicon substrate 23. The etched grooves 23a require an aspect ratio with a width of several microns and a depth of approximately 100 microns. To this end, examples of dry etching methods to form the etched grooves 23a include a Bosch process, cryo process and the like.

In FIG. 4D, gold 29 (Au) is embedded in the etched grooves 23a according to electrolytic plating with a seed layer of the conductive thin film 25. The gold 29 becomes the radiopaque areas 20. Then the silicon substrate 23 and the conductive substrate 22 are cut at a regular size, to obtain the small grating plate 19a. Note that the etch mask 27 and the conductive substrate 22 may be removed from the silicon substrate 23.

In the X-ray imaging apparatus 10, X-rays from the X-ray source 11 is partially shielded by the radiopaque areas 14a of the third diffraction grating device 14, to reduce an actual size of the focus in the x-direction, so that a great number of line light sources (discrete light sources) are defined in the x-direction. After X-rays are transmitted through the body H, there occurs a phase difference in the X-rays. When the X-rays are transmitted through the first diffraction grating device 12, there occurs a fringe image at the second diffraction grating device 13 to represent the transmission phase information of the body H determined according to its refractive index and path length of the transmission. The fringe image is modulated by the second diffraction grating device 13 for intensity modulation, and detected, for example, by a fringe scanning method.

The fringe scanning method is described now. The second diffraction grating device 13 is moved relative to the first diffraction grating device 12 in a direction along a grating surface about the X-ray focal point, and at a scan pitch obtained by equally splitting the grating pitch. During the movement of the second diffraction grating device 13, X-rays are applied to the body H by the X-ray source 11 before the X-ray image detector 15 detects the X-rays by imaging at a plurality of times. A phase differentiated image is obtained by shifts of pixel data of pixels for the phase from the X-ray image detector 15, namely a phase difference between states with and without the body H. The phase differentiated image corresponds to an angular distribution of X-rays refracted by the body. Then the phase differentiated image is integrated in the scan direction of fringe scan, to form a phase contrast image of the body.

### 1ST EMBODIMENT

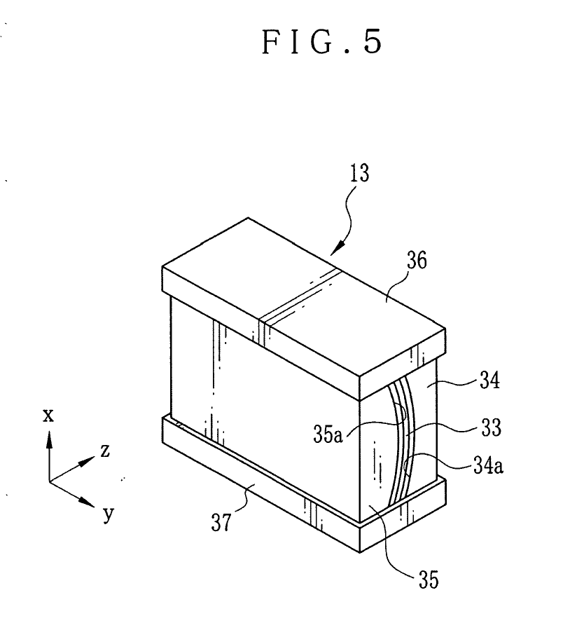

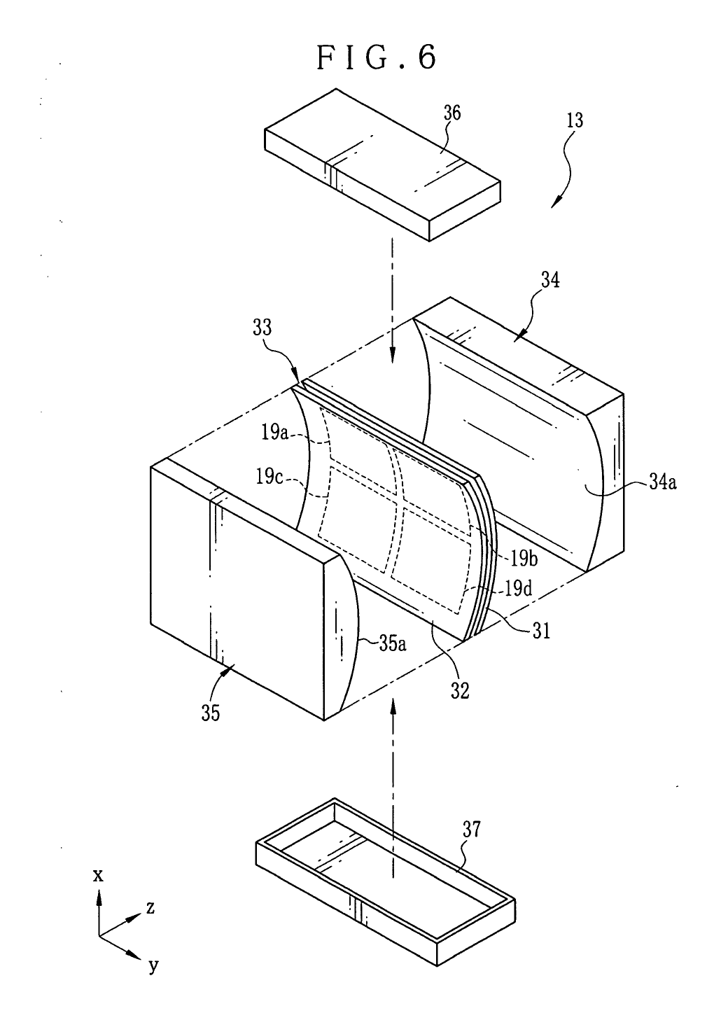

The second diffraction grating device 13 and its production method according to the invention are hereinafter described. In FIGS. 5 and 6, the second diffraction grating device 13 includes a composite grating 33, a concave holding plate 34 or covering plate or stage, a convex holding plate 35 or covering plate or stage, and clamping caps 36 and 37 for sealing and reinforcement. The composite grating 33 includes the small grating plates 19a-19d, and a first support plate 31 and a second support plate 32 for sandwiching the small grating plates 19a-19d. The concave and convex holding plates 34 and 35 sandwich the composite grating 33 in the z-direction in a curved form. The clamping caps 36 and 37 are fitted on outer sides of the concave and convex holding plates 34 and 35 in the x-direction. A concave surface 34a and a convex surface 35a are formed with respectively opposed surfaces of the concave and convex holding plates 34 and 35 as first and second holding plates, for sandwiching the composite grating 33 in a curved form. The first and second support plates 31 and 32 and the concave and convex holding plates 34 and 35 are formed from a material having a high X-ray transparency.

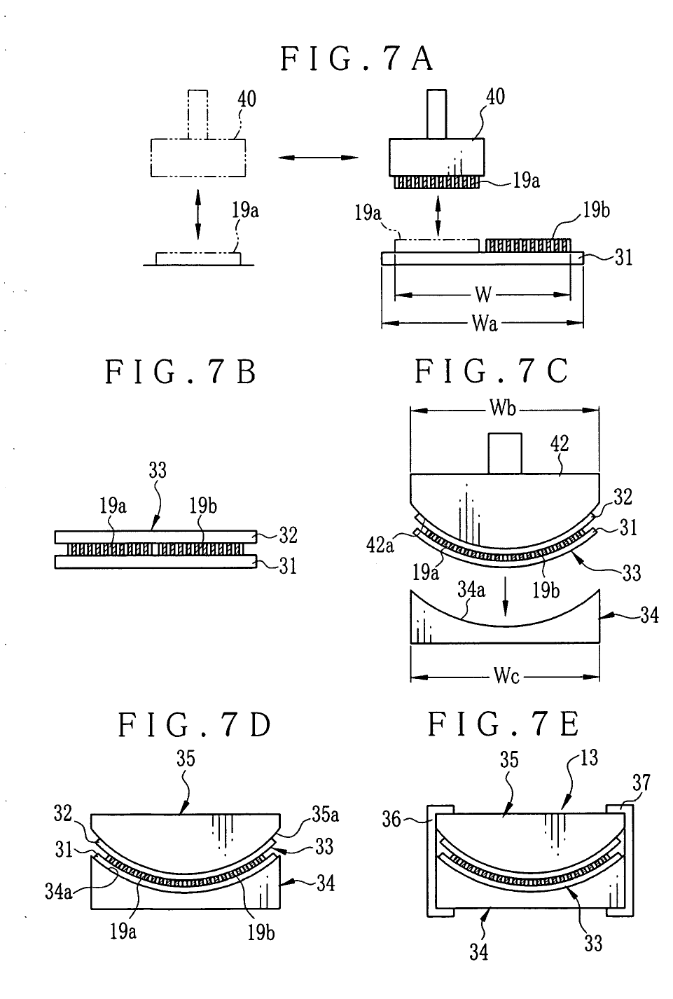

Production of the second diffraction grating device 13 is described now. In FIG. 7A, a suction pad 40 holds the small grating plate 19a by suction in an initial step. The suction pad 40 moves the small grating plate 19a and places and attaches the same to the first support plate 31 coated with adhesive agent. Also, the small grating plates 19b-19d are attached to the first support plate 31 one after another similarly to the small grating plate 19a. A width Wa of the first support plate 31 is larger than a width W of an array of the small grating plates 19a-19d in FIG. 2, so that the small grating plates 19a-19d can be mounted suitably. Indicia or marks are disposed at the center and peripheral points of the first support plate 31 for attachment of the small grating plates 19a-19d. Their positions relative to the marks are observed through a microscope and checked before attaching the small grating plates 19a-19d to the first support plate 31.

In FIG. 7B, the second support plate 32 is attached to the small grating plates 19a-19d on the first support plate 31 by adhesive agent. The second support plate 32 has a size and thickness equal to those of the first support plate 31. Thus, the composite grating 33 is produced as a single unit, inclusive of the first and second support plates 31 and 32 and the small grating plates 19a-19d sandwiched between those. Each of the small grating plates 19a-19d has as small a thickness as hundreds of microns and has a somewhat small strength, but can be protected suitably because supported between the first and second support plates 31 and 32. Handleability of the small grating plates 19a-19d is better owing to the composite grating 33.

A material of the first and second support plates 31 and 32 has high radio-transparency to X-rays and has flexibility. Examples of the material include glass, silicon, aluminum, magnesium alloy, carbon plate, acrylic resin, polycarbonate, polyethylene, polyether ether ketone (PEEK), polyimide, and the like.

In FIG. 7C, a suction pad 42 for attachment has a suction surface 42a curved convexly. In a succeeding step, the composite. grating 33 is held by the suction pad 42, kept curved by contact with the suction surface 42a, and placed on and attached to the concave surface 34a coated with adhesive agent. As the suction surface 42a is curved in a manner similar to the second diffraction grating device 13 in the X-ray imaging apparatus 10, the small grating plates 19a-19d are curved with a curvature of a radius R equal to that of the second diffraction grating device 13. Also, the concave surface 34a is curved with a curvature of a radius equal to that of the second diffraction grating device 13 in the X-ray imaging apparatus 10, the composite grating 33 remains curved to keep the small grating plates 19a-19d curved with the curvature of the radius R equal to that of the second diffraction grating device 13.

Thus, no mispositioning or no structural breakage will occur in the small grating plates 19a-19d in the course of curving, because the small grating plates 19a-19d are curved while sandwiched between the first and second support plates 31 and 32. Also, the composite grating 33 is curved by use of the suction pad 42 and then retained on the concave holding plate 34. This is effective in increasing the precision between the composite grating 33 and the concave holding plate 34 in comparison with direct access to the composite grating 33 with the concave and convex holding plates 34 and 35 for curving.

A width Wb of the suction pad 42 and a width Wc of the concave holding plate 34 are larger than the width Wa of the first and second support plates 31 and 32 in order to curve the composite grating 33 suitably. See Conditions 1 and 2 below. Note that the composite grating 33 held by the suction pad 42 can be pressed provisionally to the concave surface 34a without adhesive agent in the concave holding plate 34, for the purpose of tightly holding the composite grating 33 on the suction surface 42a.

Wb>Wa Condition 1

Wc>Wa Condition 2

In FIG. 7D for a succeeding step, the convex holding plate 35 where the convex surface 35a is coated with adhesive agent is attached to the composite grating 33 after retraction of the suction pad 42. A size of the convex holding plate 35 is equal to that of the concave holding plate 34. Thus, the composite grating 33 can be kept curved because retained firmly with the concave and convex holding plates 34 and 35. The concave and convex holding plates 34 and 35 have a low absorbance for X-rays, and have a thermal expansion coefficient near to that of the small grating plates 19a-19d. Thermal expansion coefficients of the silicon and gold contained in the small grating plates 19a-19d are 4.3 per deg. C. and 14.3 per deg. C. Therefore, examples of materials for the concave and convex holding plates 34 and 35 can be glass (8.3 per deg. C.), carbon plate (5 per deg. C.), aluminum (23 per deg. C.), iron (12×10⁻⁶ per deg. C.) and the like.

In FIG. 7E, the clamping caps 36 and 37 are fitted on the outside of the concave and convex holding plates 34 and 35 in the x-direction for sealing or reinforcing the attachment of the concave and convex holding plates 34 and 35. A material for the clamping caps 36 and 37 preferably has a high X-ray transparency. If the clamping caps 36 and 37 are formed from a material with a low X-ray transparency, the clamping caps 36 and 37 can be shaped not to extend into a region of the small grating plates 19a-19d. The clamping caps 36 and 37 may be omitted if the attachment of the concave and convex holding plates 34 and 35 is sufficiently strong with adhesive agent. Also, it is possible to secure the concave and convex holding plates 34 and 35 without adhesive agent. Specifically, the composite grating 33 is sandwiched between the concave and convex holding plates 34 and 35, which can be secured firmly by use of screws or the like.

As described heretofore, it is possible with high precision to dispose the small grating plates 19a-19d on the first support plate 31 because the small grating plates 19a-19d are attached to the first support plate 31 of a flat shape. The radiopaque areas and X-ray transparent areas in those can be aligned precisely as well as relative positioning between the small grating plates 19a-19d. Also, the small grating plates 19a-19d can be protected safely because sandwiched tightly between the first and second support plates 31 and 32. The composite grating 33 is curved so that the small grating plates 19a-19d can be curved suitably in a protected condition. The small grating plates 19a-19d can be prevented from breaking even in the curved state. The composite grating 33 can remain curved suitably because retained firmly by the concave and convex holding plates 34 and 35.

As the second diffraction grating device 13 according to the invention is used in the X-ray imaging apparatus 10 or radiation imaging apparatus, it is possible to assemble the small grating plates 19a-19d within the X-ray imaging apparatus 10 with a sufficient strength without breakage in spite of their very small thickness after production in the semiconductor process of silicon.

Note that the a lower surface of the concave holding plate 34 and an upper surface of the convex holding plate 35 can be formed arcuately to follow the curvature of the small grating plates 19a-19d so as to regularize an absorption amount of X-rays in the concave and convex holding plates 34 and 35 relative to the small grating plates 19a-19d.

### 2ND EMBODIMENT

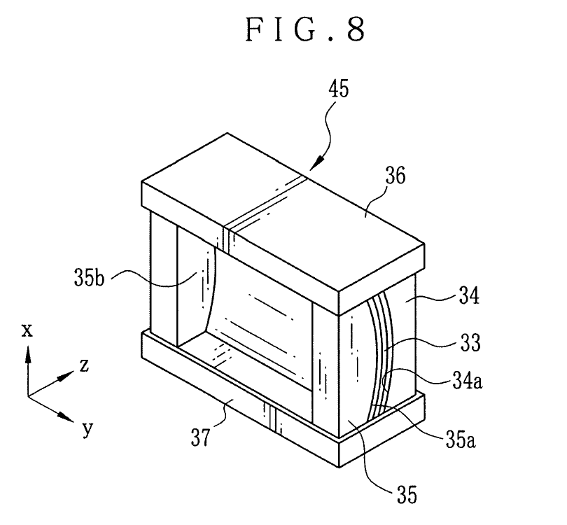

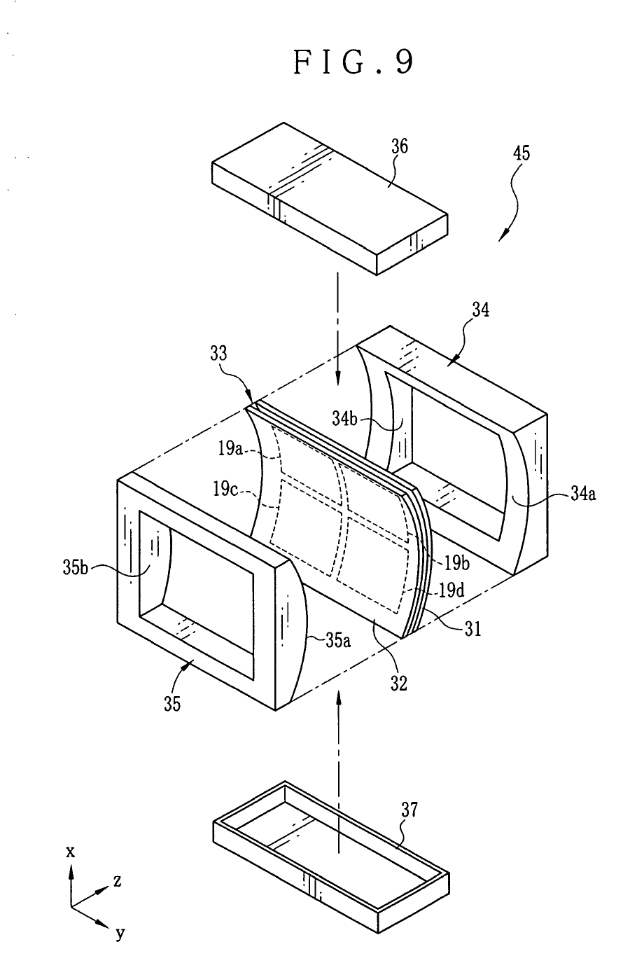

In contrast with the concave and convex holding plates 34 and 35 in the first embodiment, a second diffraction grating device 45 of FIGS. 8 and 9 includes an opening 34b in the concave holding plate 34 and an opening 35b in the convex holding plate 35 for the small grating plates 19a-19d. In short, the concave and convex holding plates 34 and 35 can be formed in a frame shape. This structure is effective in increasing the X-ray transparency.

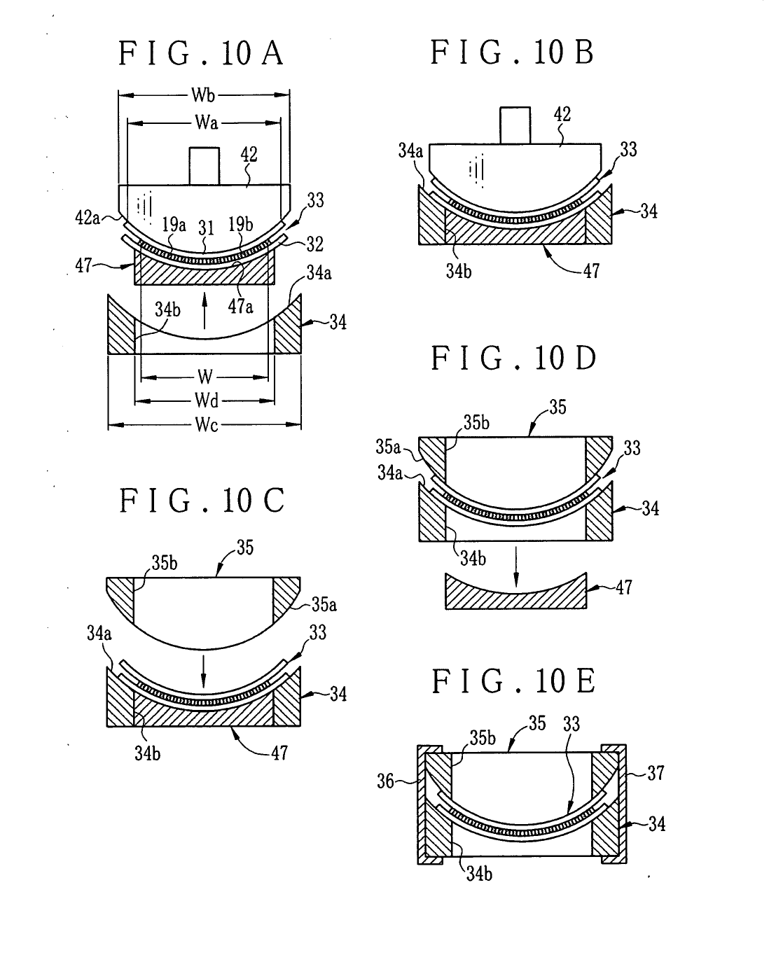

FIGS. 10A-10E illustrate production of the second diffraction grating device 45. For the production of the composite grating 33, the first embodiment is repeated. In FIG. 10A, an additional support pad 47 includes a second concave surface 47a for entry in the opening 34b of the concave holding plate 34. In an initial step, the composite grating 33 is squeezed between the second concave surface 47a and the suction pad 42. The second concave surface 47a is so concave as to connect smoothly with the concave surface 34a when the concave holding plate 34 rises to enter the support pad 47 in the opening 34b.

In FIG. 10B, the concave holding plate 34 is moved up for the concave surface 34a to contact the composite grating 33. As the concave surface 34a is coated with adhesive agent, peripheral portions of the composite grating 33 are attached to the concave holding plate 34. Also, the support pad 47 comes to enter the opening 34b of the concave holding plate 34.

In FIG. 10C, the suction pad 42 moves away from the composite grating 33. The convex holding plate 35 with adhesive agent on the convex surface 35a is attached to the composite grating 33. In FIG. 10D, the support pad 47 is moved down and away from the composite grating 33. Thus, the composite grating 33 is supported only by the concave and convex holding plates 34 and 35. The openings 34b and 35b become set to open in an area of the small grating plates 19a-19d. In FIG. 10E, the clamping caps 36 and 37 for sealing are fitted on outer sides of the concave and convex holding plates 34 and 35.

In the embodiment, the width Wb of the suction pad 42 is larger than the width Wa of the first and second support plates 31 and 32 for the purpose of suitably curving the composite grating 33 with the suction pad 42 in the manner of Condition 1. Also, the concave and convex surfaces 34a and 35a disposed locally on the concave and convex holding plates 34 and 35 should support the composite grating 33 reliably. To this end, the width Wc of the concave and convex holding plates 34 and 35, a width Wd of the openings 34b and 35b and the width Wa of the first and second support plates 31 and 32 satisfy Condition 3 below. Furthermore, the width W of the small grating plates 19a-19d and the width Wd of the openings 34b and 35b satisfy Condition 4 below, so that the small grating plates 19a-19d are present within the area of the openings 34b and 35b.

Wc>Wa>Wd Condition 3

W<Wd Condition 4

Thus, X-ray transparency can be high according to the openings 34b and 35b open in the area of the small grating plates 19a-19d. Note that the a lower surface of the concave holding plate 34 and an upper surface of the convex holding plate 35 can be formed arcuately to follow the curvature of the small grating plates 19a-19d in a manner similar to the first embodiment. This is effective in regularizing an absorption amount of X-rays in the concave and convex holding plates 34 and 35 relative to the small grating plates 19a-19d.

### 3RD EMBODIMENT

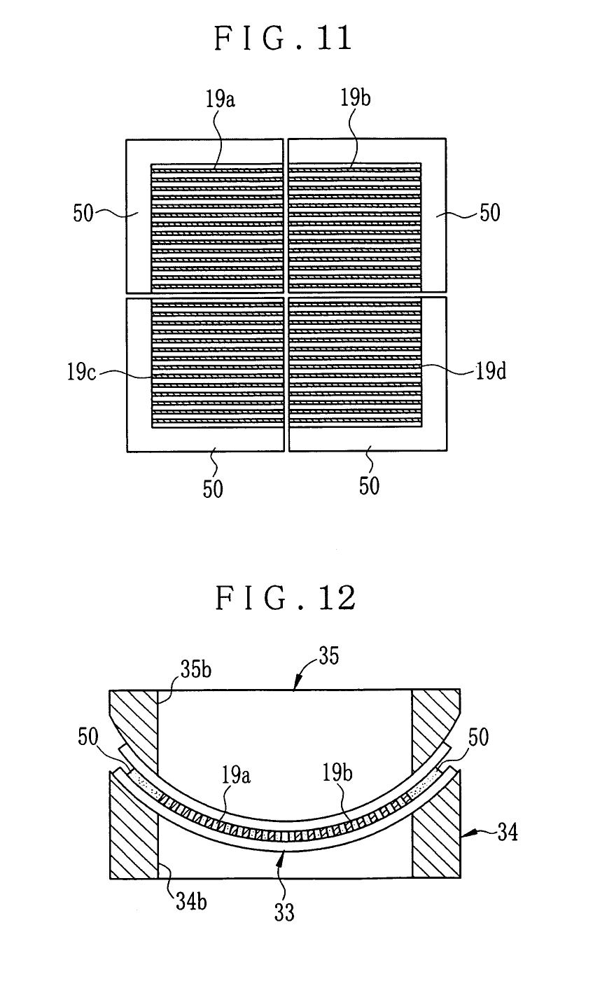

Furthermore, reinforcing portions can be formed with small grating plates for higher mechanical strength on their periphery by use of silicon. In FIG. 11, L-shaped reinforcing portions 50 are formed with two of the side lines of each of the small grating plates 19a-19d in the four-plate structure. In short, the reinforcing portions 50 are arranged on the periphery of the entirety of the combination of the small grating plates 19a-19d. See FIG. 12. To sandwich the composite grating 33 between the concave and convex holding plates 34 and 35, the reinforcing portions 50 are effective in preventing collapse of the periphery of the small grating plates 19a-19d with pressure of the concave and convex holding plates 34 and 35. It is possible to utilize even edge portions of the small grating plates 19a-19d optically as diffraction gratings.

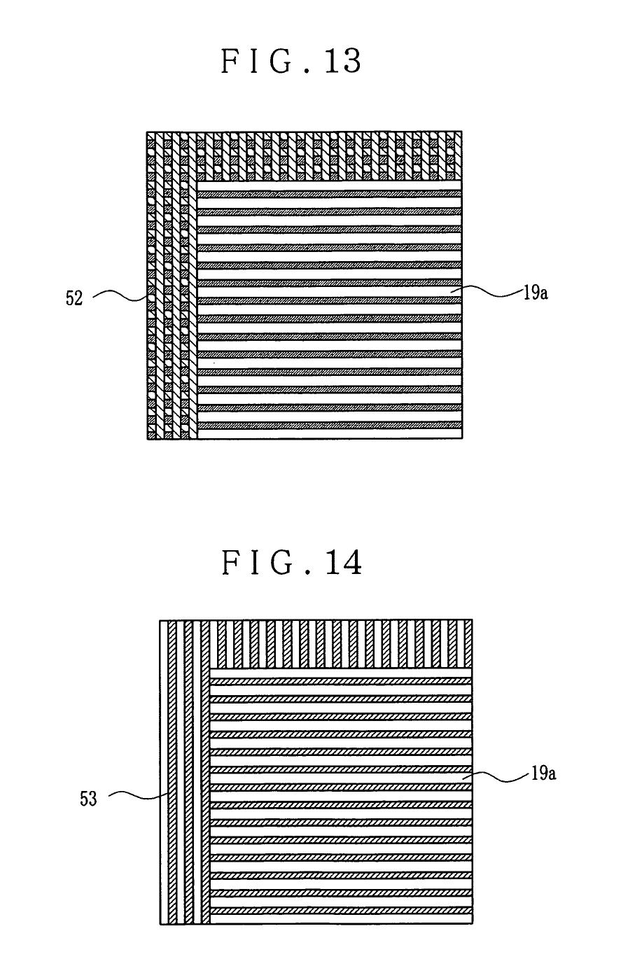

In FIG. 13, a reinforcing portion 52 of another example is illustrated, and is in an L shape where silicon and gold (Au) are positioned alternately and crosswise. In FIG. 14, another preferred reinforcing portion 53 is illustrated, in which a grating form is perpendicular to a grating portion of the small grating plate 19a with silicon and gold (Au).

### 4TH EMBODIMENT

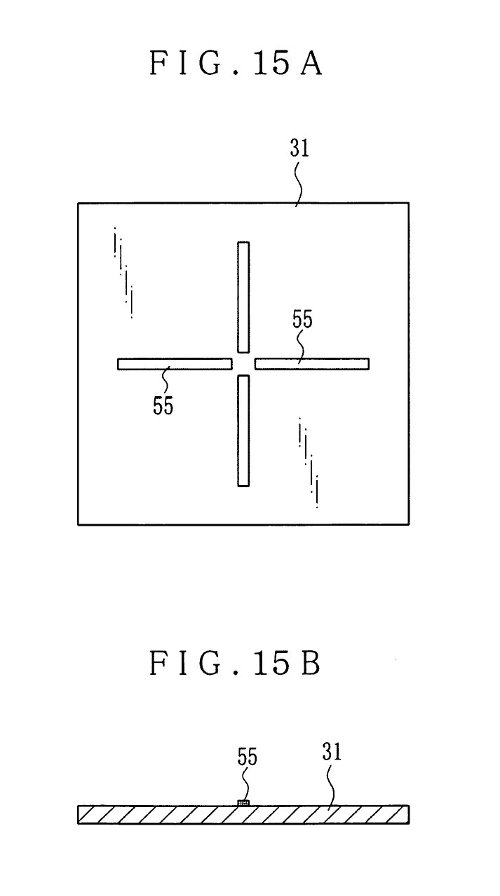

In FIG. 15A, indicia 55 or marks for positioning can be disposed on an upper surface of the first support plate 31 for initially attaching the small grating plates 19a-19d. For the four-plate structure of the small grating plates 19a-19d, the indicia 55 can preferably have a cross shape for determining the intervals between the small grating plates 19a-19d. In FIG. 15B, a preferred form of the indicia 55 is illustrated, and is ridges projecting from the first support plate 31. The ridges are formed from resist or thin metal with a thickness of 100 microns or so. Edges of the small grating plates 19a-19d can contact the ridges of the indicia 55 tightly and can be positioned suitably. Those structures facilitate the positioning of the small grating plates 19a-19d with the first support plate 31. Precision of the positioning will be remarkably high.

### 5TH EMBODIMENT

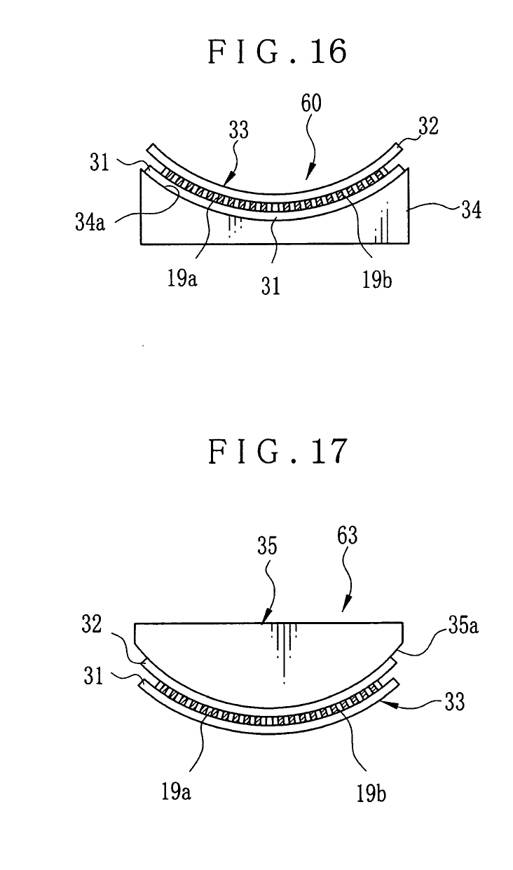

In each of the above embodiments, the composite grating 33 is sandwiched between the concave and convex holding plates 34 and 35. In FIG. 16, another second diffraction grating device 60 is illustrated, in which the composite grating 33 is retained only by the concave holding plate 34. In FIG. 17, a second diffraction grating device 63 is illustrated, in which the composite grating 33 is retained only by the convex holding plate 35. It is also possible to increase radio-transparency of the composite grating 33 to X-rays by use of only one holding plate or stage. A manufacturing cost can be reduced by reducing the number of parts and the number of steps of the production. It is also possible to assemble very thin small grating plates in an X-ray imaging apparatus with a sufficiently high rigidity.

### 6TH EMBODIMENT

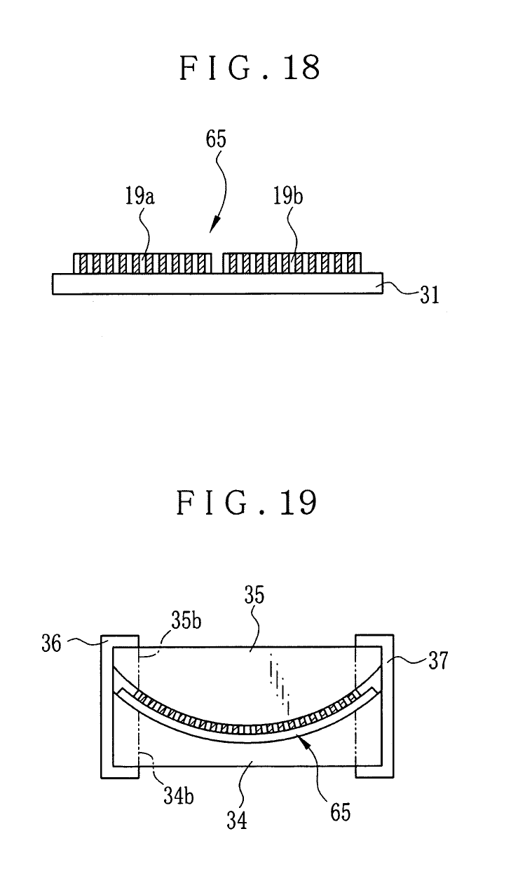

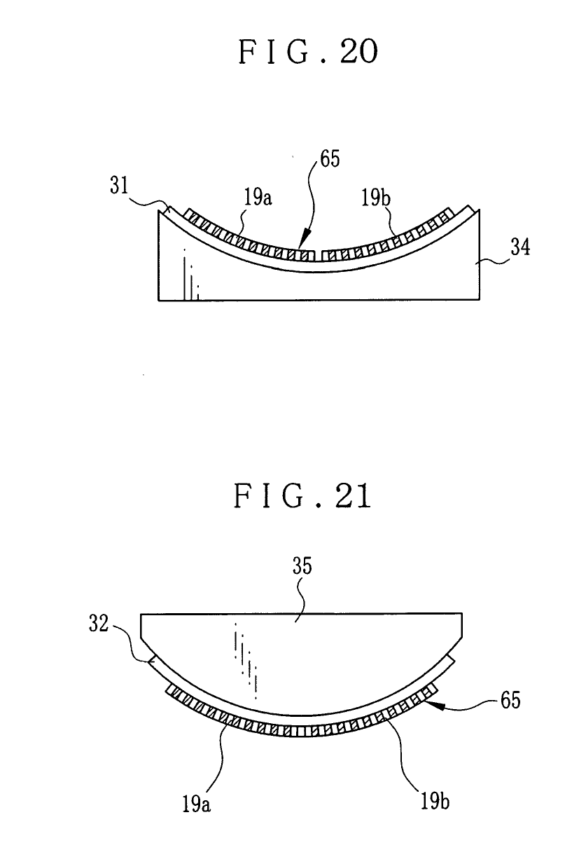

In the above embodiments, the composite grating 33 has the first and second support plates 31 and 32. Furthermore, as illustrated in FIG. 18, a composite grating 65 can be constituted by the first support plate 31 and the small grating plates 19a-19d. As illustrated in FIG. 19, the composite grating 65 may be sandwiched between the concave and convex holding plates 34 and 35, and also between those having the openings 34b and 35b indicated by the phantom line. As illustrated in FIGS. 20 and 21, the composite grating 65 may be retained only by the concave holding plate 34 or by the convex holding plate 35. In the present embodiments, it is possible to increase the X-ray transparency owing to no use the second support plate 32. Also, the manufacturing cost can be reduced by reducing the number of parts and the number of steps in the manufacture. The very thin small grating plates can be incorporated in the X-ray imaging apparatus with a sufficient strength.

### 7TH EMBODIMENT

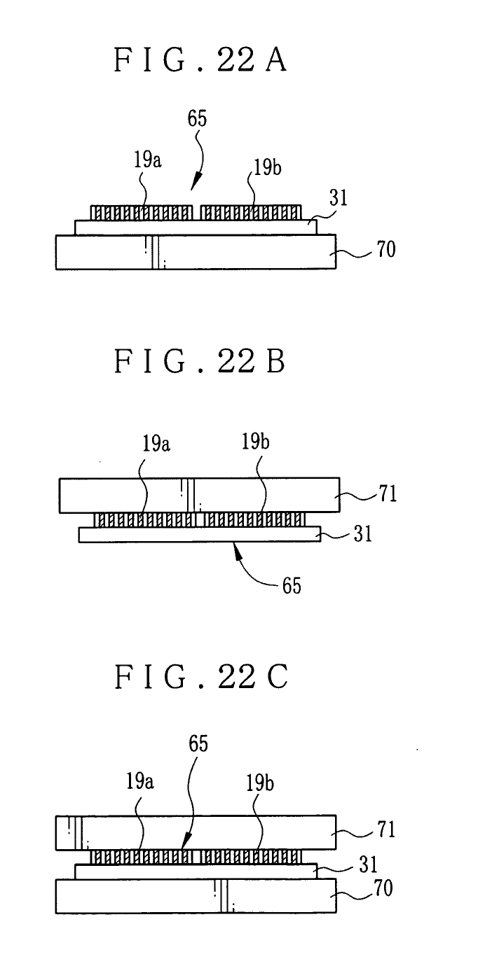

Furthermore, the composite grating 33 of FIG. 7D and the composite grating 65 of FIG. 18 can be used solely as a diffraction grating device. Although the above holding plates are curved, it is possible to use flat holding plates 70 and 71 or covering plates or stages of FIGS. 22A-22C. Other various examples of forms of surfaces of holding plates or stages may be used. The composite grating 33 may be supported or sandwiched by the flat holding plates 70 and 71. In a manner similar to the fifth and sixth embodiments, it is possible to increase radio-transparency for X-rays and reduce the manufacturing cost by reducing the number of parts and the number of steps of the production. Very thin small grating plates can be assembled in an X-ray imaging apparatus with a sufficiently high rigidity.

### COMPARATIVE EXAMPLE

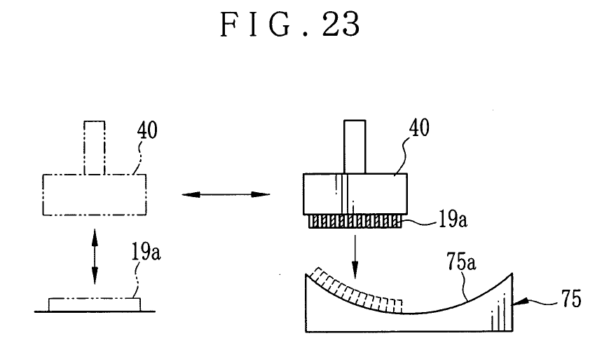

For the purpose of comparison, a comparative example distinct from the above-described embodiments is described now. In FIG. 23, a concave holding plate 75 or covering plate or stage has a concave surface 75a. The small grating plate 19a is held by the suction pad 40, and placed on and attached directly to the concave surface 75a. This process is according to known techniques including the disclosures of JP-A 9-304738 and JP-A 2001-330716. In a manner similar to the embodiments, positions of the small grating plates 19a-19d relative to the marks are observed through a microscope and checked before attaching the small grating plates 19a-19d to the concave surface 75a, the marks being disposed at the center and peripheral points of the concave surface 75a.

However, there occurs a difference between positions of the center mark and peripheral marks on the concave surface 75a in a vertical direction, the difference being as much as a curve height k of the second diffraction grating device 13, for example 3 mm. A problem arises in that much time is required for the adjustment due to impossibility of simultaneous focusing of the center mark and peripheral marks with the microscope. If the small grating plate 19a is placed on the concave surface 75a for attachment by shifting the suction pad 40 vertically, it is likely that breakage, unevenness in the adhesion, or mispositioning occurs in the small grating plate 19a due to uneven force applied to the small grating plate 19a with an inclination. No suitable attachment can be carried out. In contrast with the comparative example, those problems are solved according to the feature of the above-described embodiments of the invention. No failure in the comparative example occurs.

A diffraction grating device of the invention may be the first diffraction grating device 12 or the third diffraction grating device 14 in place of the second diffraction grating device 13 of the above embodiments. In the above embodiments, the second support plate is combined with the first support plate to sandwich the small grating plates. Furthermore, the first support plate may be combined with an element other than the second support plate, for example, a coating of a protective layer, such as palylene (polymonochloroparaxylylene), silicone and the like, and a protective film, such as PET, polystyrene, aluminum foil and the like. In the above embodiment, the curved surface of a diffraction grating device is cylindrical. However, a curved surface of a diffraction grating device of the invention can be spherical. Features of the above embodiments can be combined with one another in a range without problems. In the above embodiments, the diffraction grating device is for the X-ray imaging apparatus with the Talbot effect. Furthermore, a diffraction grating device in the invention may be for an X-ray imaging apparatus for a phase contrast image without the Talbot effect as interference effect.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A grating production method of producing a diffraction grating device, comprising steps of:
securing at least one small grating plate to a first support plate being radio-transparent to obtain a composite grating, said small grating plate having radiopaque areas and radio-transparent areas arranged in a grating pattern;
curving said composite grating to obtain said diffraction grating device.

2. A grating production method as defined in claim 1, wherein said small grating plate is constituted by plural small grating plates arranged in aligning said radiopaque areas thereof.

3. A grating production method as defined in claim 2, further comprising a step of securing a second support plate being radio-transparent to said small grating plate secured to said first support plate, to sandwich said small grating plate between said first and second support plates.

4. A grating production method as defined in claim 3, wherein in said curving step, said composite grating is curved along on a concave or convex first surface of a first holding plate.

5. A grating production method as defined in claim 4, wherein said curving step includes:
holding said composite grating for curving by suction of a suction device being concave or convex corresponding to said first surface;
moving one of said suction device and said first holding plate relatively toward another thereof;
discontinuing said suction of said suction device to set said composite grating on said first surface.

6. A grating production method as defined in claim 5, wherein said first holding plate has an opening formed in an area of said small grating plate;
said moving of said composite grating includes:
retaining said composite grating held on said suction device by use of an additional support pad disposed movably into and out of said opening;
squeezing said composite grating between said first holding plate and said suction device by moving said first holding plate toward said composite grating;
moving away said suction device and said support pad from said composite grating.

7. A grating production method as defined in claim 1, wherein a second holding plate is further placed on said composite grating retained on said first holding plate, to sandwich said composite grating between said first and second holding plates.

8. A grating production method as defined in claim 7, wherein said second holding plate has an opening formed in an area of said small grating plate.

9. A grating production method as defined in claim 1, wherein said small grating plate includes a reinforcing portion formed along a peripheral edge thereof.

10. A grating production method as defined in claim 1, wherein said first support plate includes an indicia for positioning said small grating plate to be secured.

11. A grating production method as defined in claim 10, wherein said indicia is a projection for receiving contact of edges of said small grating plate.

12. A diffraction grating device comprising:
at least one small grating plate having radiopaque areas and radio-transparent areas arranged in a grating pattern;
first and second support plates being radio-transparent, secured to said small grating plate, for sandwiching thereof.

13. A diffraction grating device as defined in claim 12, further comprising a first holding plate being radio-transparent, for retaining a composite grating including said small grating plate and said first and second support plates.

14. A diffraction grating device as defined in claim 13, wherein said first holding plate includes a first surface being concave or convex, and said composite grating is curved along said first surface.

15. A diffraction grating device as defined in claim 14, further comprising a second holding plate being radio-transparent, secured to said composite grating, for sandwiching in cooperation with said first holding plate.

16. A diffraction grating device as defined in claim 15, further comprising an opening formed in each of said first and second holding plates in an area of said small grating plate.

17. A diffraction grating device as defined in claim 15, further comprising a clamping portion for squeezing said first and second holding plates for sealing.

18. A diffraction grating device as defined in claim 12, wherein said small grating plate is constituted by plural small grating plates arranged in aligning said radiopaque areas thereof.

19. A diffraction grating device as defined in claim 12, further comprising a reinforcing portion for reinforcing a peripheral portion of said small grating plate.

20. A diffraction grating device comprising:
a composite grating, including at least one small grating plate having radiopaque areas and radio-transparent areas arranged in a grating pattern, and a first support plate being radio-transparent, for receiving said small grating plate secured thereto;
a first holding plate being radio-transparent, for retaining said composite grating thereon.

21. A diffraction grating device as defined in claim 20, wherein said first holding plate includes a first surface being concave or convex, and said composite grating is curved along said first surface.

22. A diffraction grating device as defined in claim 20, further comprising a second support plate being radio-transparent, for sandwiching said small grating plate in cooperation with said first support plate.

23. A radiation imaging apparatus comprising:
a radiation source for emitting radiation;
a first diffraction grating device for creating a fringe image by transmitting said radiation;
a second diffraction grating device for intensity modulation of said fringe image in plural relative positions being out of phase with a fringe pattern of said fringe image;
a radiation detector for detecting said fringe image after said intensity modulation in said relative positions from said second diffraction grating device;
wherein at least one of said first and second diffraction grating devices includes:
at least one small grating plate having radiopaque areas and radio-transparent areas arranged in a grating pattern;
first and second support plates being radio-transparent, secured to said small grating plate, for sandwiching thereof.

24. A radiation imaging apparatus comprising:
a radiation source for emitting radiation;
a first diffraction grating device for creating a fringe image by transmitting said radiation;
a second diffraction grating device for intensity modulation of said fringe image in plural relative positions being out of phase with a fringe pattern of said fringe image;
a radiation detector for detecting said fringe image after said intensity modulation in said relative positions from said second diffraction grating device;
wherein at least one of said first and second diffraction grating devices includes:
a composite grating, including at least one small grating plate having radiopaque areas and radio-transparent areas arranged in a grating pattern, and a first support plate being radio-transparent, for receiving said small grating plate secured thereto;
a first holding plate being radio-transparent, for supporting said composite grating thereon.
